(19) United States
(12) Patent Application Publication
(10) Pub. No.: US 2024/0125403 A1
(43) Pub. Date: Apr. 18, 2024

(54) Reversing Valve

(71) Applicant: ZHEJIANG DUNAN ARTIFICIAL ENVIRONMENT CO., LTD., Shaoxing, Zhejiang (CN)

(72) Inventors: Yujian DUAN, Shaoxing, Zhejiang (CN); Haibo LIU, Shaoxing, Zhejiang (CN); Yukuan SHAN, Shaoxing, Zhejiang (CN)

(21) Appl. No.: 18/276,057

(22) PCT Filed: Jan. 10, 2022
(86) PCT No.: PCT/CN2022/071096

§ 371 Date: Aug. 7, 2023

(30) Foreign Application Priority Data
Feb. 7, 2021 (CN) 202120349755.8

(51) Int. Cl. F16K 27/00; F16K 31/36

(52) U.S. Cl. CPC F16K 27/00; F16K 31/36

(57) ABSTRACT

Provided is a reversing valve. The reversing valve includes: a main valve; a supporting frame having a first connecting end and a second connecting end, wherein the first connecting end is connected with the main valve, and an end wall of the first connecting end is attached to a side wall of the main valve; and a supporting structure located between a side wall of the first connecting end and the side wall of the main valve. Strength of connection between the main valve and the supporting frame of the reversing valve is high, thereby achieving safety and reliability.

### CROSS-REFERENCE TO RELATED APPLICATION

The disclosure claims priority to Patent Application No. 202120349755.8, filed to the China National Intellectual Property Administration on Feb. 7, 2021 and entitled “Reversing Valve”.

### TECHNICAL FIELD

The disclosure relates to the technical field of reversing valves, and particularly relates to a reversing valve.

### BACKGROUND

A four-way valve includes a main valve, a pilot valve and a supporting frame. The main valve and the pilot valve are integrally connected by the supporting frame, and the working state of the main valve is controlled by the pilot valve.

In the related art, strength of connection between the main valve and the supporting frame is insufficient.

### SUMMARY

The disclosure provides a reversing valve, so as to solve the problem of insufficient strength of connection between a main valve and a supporting frame in the related art.

The disclosure provides a reversing valve. The reversing valve includes: a main valve; a supporting frame having a first connecting end and a second connecting end, wherein the first connecting end is connected with the main valve, and an end wall of the first connecting end is attached to a side wall of the main valve; and a supporting structure located between a side wall of the first connecting end and the side wall of the main valve.

According to the technical solution of the disclosure, the reversing valve includes the main valve, the supporting frame and the supporting structure, the first connecting end of the supporting frame is connected with the main valve, and the end wall of the first connecting end is attached to the side wall of the main valve, such that the main valve is fixedly connected with the supporting frame. By arranging the supporting structure between the side wall of the first connecting end and the side wall of the main valve, connection strength and connection stability of the main valve and the supporting frame may be enhanced by the supporting structure.

In some embodiments, the supporting frame includes a frame body and a connecting plate that are connected to each other, a surface of the connecting plate is attached to the side wall of the main valve, and the supporting structure is located between a side wall of the frame body and the side wall of the main valve such that connection may be facilitated; and/or the supporting structure is located between a side wall of the connecting plate and the side wall of the main valve, so as to further enhance connection firmness.

In some embodiments, the frame body includes a first supporting plate and a second supporting plate, the first supporting plate and the second supporting plate are arranged at an interval in an axial direction of the main valve, and two ends of the connecting plate are connected with the first supporting plate and the second supporting plate respectively. The first supporting plate and the second supporting plate are simultaneously used for support such that support stability may be improved. There are a plurality of supporting structures. The plurality of supporting structures are arranged between an outer side wall of the first supporting plate and the side wall of the main valve and between an outer side wall of the second supporting plate and the side wall of the main valve, so as to further improve connection strength.

In some embodiments, the connecting plate includes a first side wall, a second side wall, a third side wall and a fourth side wall, the first side wall and the third side wall both extend in a circumferential direction of the main valve, the second side wall and the fourth side wall both extend in an axial direction of the main valve, there are a plurality of supporting structures, and the plurality of supporting structures are arranged between the second side wall and the side wall of the main valve and between the fourth side wall and the side wall of the main valve. Connection strength and connection stability of the main valve and the supporting frame may be enhanced similarly by the supporting structure, so as to satisfy use requirements.

In some embodiments, the supporting structure includes a supporting member, and the side wall of the first connecting end and the side wall of the main valve are connected with the supporting member respectively. The main valve and the supporting frame are connected and supported by the supporting member, so as to enhance connection strength of the main valve and the supporting frame.

In some embodiments, a section shape of the supporting member includes a triangle, a rectangle, a sector or a circle such that various use requirements may be satisfied.

In some embodiments, an outer surface of the supporting member is a concave curved surface or a convex curved surface, and transition of the supporting member is smoother such that scratching may be avoided.

In some embodiments, the first connecting end is connected with the main valve through argon arc welding, and the supporting structure is a stacked material formed by welding. The supporting structure is formed by the stacked material welded by argon arc welding, such that the structure is simple, firmness is high, and assembly is convenient. Moreover, the argon arc welding is lower in cost than brazing.

In some embodiments, the supporting member is welded between the side wall of the first connecting end and the side wall of the main valve, such that connection firmness is high.

In some embodiments, the reversing valve further includes a pilot valve, wherein the pilot valve is connected with the second connecting end, and the pilot valve is connected with the main valve by the supporting frame. A working state of the main valve may be controlled by the pilot valve.

### BRIEF DESCRIPTION OF THE DRAWINGS

Accompanying drawings of the description serve as a constituent part of the disclosure to provide a further understanding of the disclosure. Embodiments of the disclosure and their descriptions serve to explain the disclosure, and are not to be construed as unduly limiting the disclosure. In the accompanying drawings:

FIG. 1 shows a schematic structural diagram of a reversing valve provided in Embodiment 1 of the disclosure;

FIG. 2 shows a schematic structural diagram of the reversing valve provided in Embodiment 1 of the disclosure;

FIG. 3 shows a schematic structural diagram of the reversing valve provided in Embodiment 1 of the disclosure;

FIG. 4 shows a schematic structural diagram of a reversing valve provided in Embodiment 2 of the disclosure;

FIG. 5 shows a schematic structural diagram of the reversing valve provided in Embodiment 2 of the disclosure;

FIG. 6 shows a schematic structural diagram of the reversing valve provided in Embodiment 2 of the disclosure;

FIG. 7 shows a schematic structural diagram of a reversing valve provided in Embodiment 3 of the disclosure;

FIG. 8 shows a schematic structural diagram of the reversing valve provided in Embodiment 3 of the disclosure;

FIG. 9 shows a schematic structural diagram of the reversing valve provided in Embodiment 3 of the disclosure;

FIG. 10 shows a schematic structural diagram of a reversing valve provided in Embodiment 4 of the disclosure;

FIG. 11 shows a schematic structural diagram of the reversing valve provided in Embodiment 4 of the disclosure; and

FIG. 12 shows a schematic structural diagram of the reversing valve provided in Embodiment 4 of the disclosure.

The above figures include reference numerals as follows:
10. main valve, 20. supporting frame, 21. first connecting end, 22. second connecting end, 23. frame body, 231. first supporting plate, 232. second supporting plate, 24. connecting plate, 241. first side wall, 242. second side wall, 243. third side wall, 244. fourth side wall, 30. supporting structure, and 31. supporting member.

### DETAILED DESCRIPTION OF THE EMBODIMENTS

Technical solutions of embodiments of the disclosure will be clearly and completely described in combination with accompanying drawings of the embodiments of the disclosure. Obviously, the embodiments described are merely some embodiments rather than all embodiments of the disclosure. The following description of at least one embodiment is merely illustrative actually and in no way serves as any limitation of the disclosure and its application or use. On the basis of embodiments of the disclosure, all other embodiments derived by those of ordinary skill in the art without creative efforts all fall within the scope of protection of the disclosure.

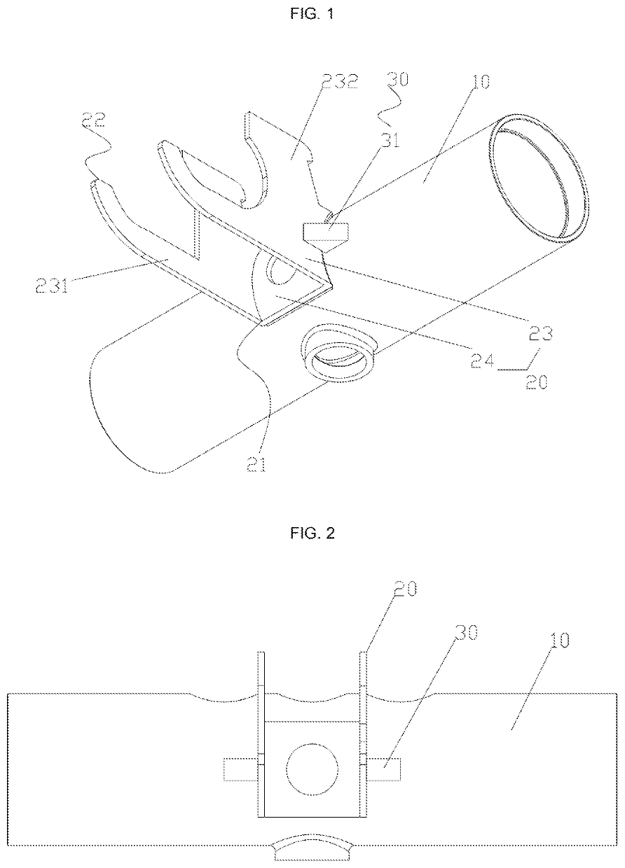

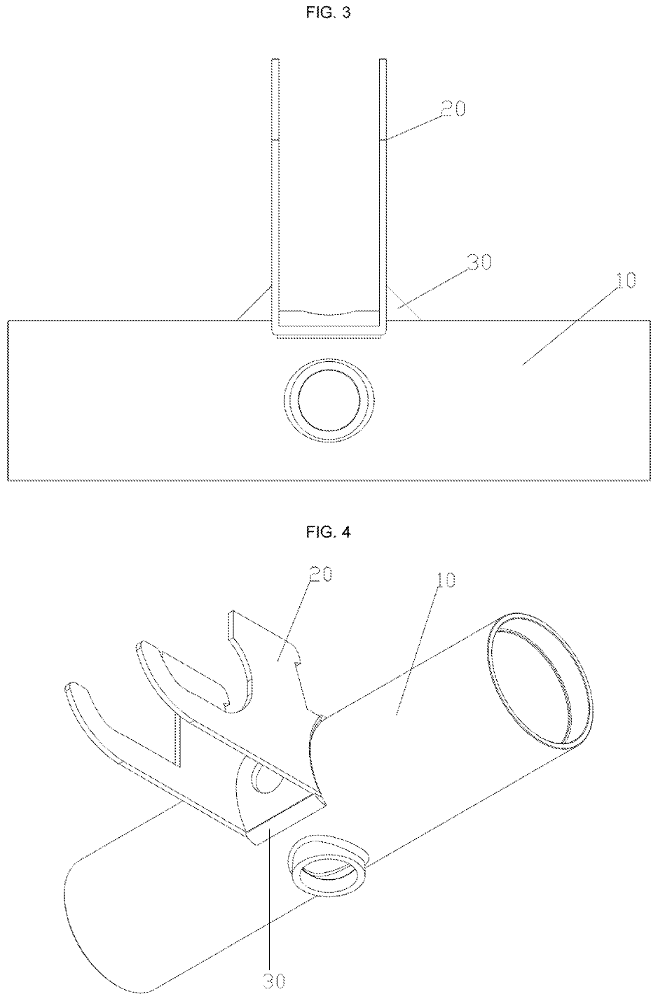

As shown in FIGS. 1-3, Embodiment 1 of the disclosure provides a reversing valve. The reversing valve includes a main valve 10, a supporting frame 20 and a supporting structure 30. The supporting frame 20 has a first connecting end 21 and a second connecting end 22, the first connecting end 21 is connected with the main valve 10, and an end wall of the first connecting end 21 is attached to a side wall of the main valve 10, such that the main valve 10 is connected with the supporting frame 20. In the embodiment, the supporting structure 30 is located between the side wall of the first connecting end 21 and the side wall of the main valve 10.

According to the reversing valve provided in the embodiment, by arranging the supporting structure 30 between the side wall of the first connecting end 21 and the side wall of the main valve 10, connection strength and connection stability of the main valve 10 and the supporting frame 20 may be enhanced by the supporting structure 30, so as to satisfy use requirements.

It should be noted that the supporting structure 30 includes component independently arranged, and further includes stacked material formed by welding.

As shown in FIG. 1, the supporting frame 20 includes a frame body 23 and a connecting plate 24 that are connected to each other, the connecting plate 24 is located at the first connecting end 21 of the supporting frame 20, and a surface of the connecting plate 24 is attached to the side wall of the main valve 10. In the embodiment, the supporting structure 30 is located between a side wall of the frame body 23 and the side wall of the main valve 10, such that connection is facilitated.

In other embodiments, the supporting structure 30 may be located between a side wall of the connecting plate 24 and the side wall of the main valve 10, or the supporting structure 30 may be arranged between the side wall of the frame body 23 and the side wall of the main valve 10 and between the side wall of the connecting plate 24 and the side wall of the main valve simultaneously, so as to further improve connection firmness.

Specifically, the frame body 23 includes a first supporting plate 231 and a second supporting plate 232, the first supporting plate 231 and the second supporting plate 232 are arranged at an interval in an axial direction of the main valve 10, and two ends of the connecting plate 24 are connected with the first supporting plate 231 and the second supporting plate 232 respectively. The first supporting plate 231 and the second supporting plate 232 are simultaneously used for support such that support stability may be improved.

In the embodiment, there are a plurality of supporting structures 30, the plurality of supporting structures 30 are arranged between an outer side wall of the first supporting plate 231 and the side wall of the main valve 10 and between the second supporting plate 232 and the side wall of the main valve, so as to further improve connection strength.

In the embodiment, the first supporting plate 231 and the second supporting plate 232 are arranged in parallel, and the first supporting plate 231 and the second supporting plate 232 are both perpendicular to the side wall of the main valve 10. Specifically, the outer side wall of the first supporting plate 231 and the outer side wall of the second supporting plate 232 are both perpendicular to the side wall of the main valve 10.

As shown in FIG. 1, the supporting structure 30 includes a supporting member 31, and the side wall of the first connecting end 21 and the side wall of the main valve 10 are connected with the supporting member 31 respectively. The main valve 10 and the supporting frame 20 are connected and supported by the supporting member 31, such that connection strength of the main valve 10 and the supporting frame 20 is enhanced.

A section shape of the supporting member 31 includes a triangle, a rectangle, a sector or a circle such that various use requirements may be satisfied. In the embodiment, the section shape of the supporting member 31 is the triangle.

In the embodiment, the first connecting end 21 is connected with the main valve 10 through argon arc welding, and the supporting structure 30 is a stacked material formed by welding. The supporting structure 30 is formed by the stacked material welded by argon arc welding, and has the advantages of being simple in structure, high in firmness and convenient to assemble. Moreover, the argon arc welding is lower in cost than brazing.

Specifically, the supporting member 31 is the stacked material welded by the argon arc welding, and the stacked material is located at a junction between the supporting frame 20 and the main valve 10.

In other embodiments, the supporting member 31 may be set as an independent component, and the supporting member 31 is welded between the side wall of the first connecting end 21 and the side wall of the main valve 10, such that connection firmness is high.

In the embodiment, the reversing valve further includes a pilot valve, wherein the pilot valve is connected with the second connecting end 22, and the pilot valve is connected with the main valve 10 by the supporting frame 20. A working state of the main valve 10 may be controlled by the pilot valve.

In the embodiment, the reversing valve includes a four-way valve.

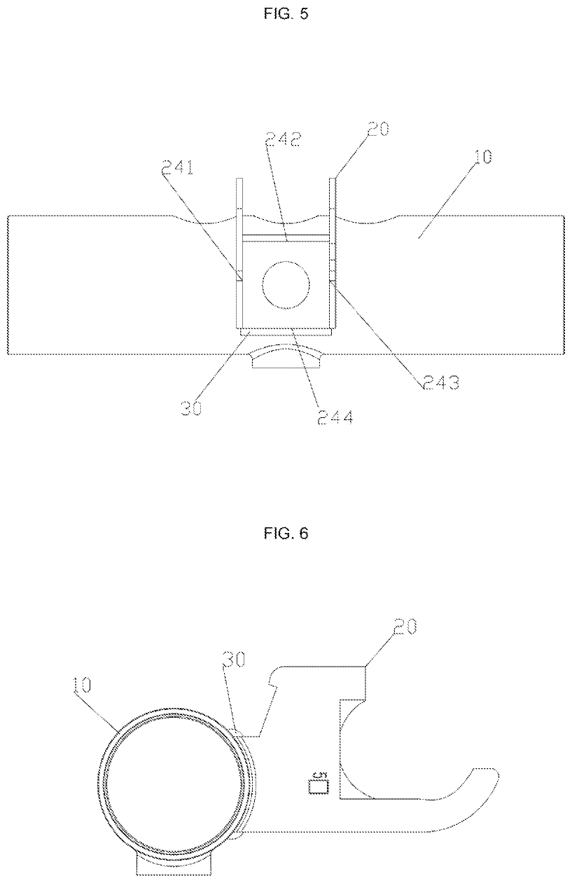

As shown in FIGS. 4-6, Embodiment 2 of the disclosure provides a reversing valve. In Embodiment 2, the connecting plate 24 includes a first side wall 241, a second side wall 242, a third side wall 243 and a fourth side wall 244, the first side wall 241 and the third side wall 243 both extend in a circumferential direction of the main valve 10, and the second side wall 242 and the fourth side wall 244 both extend in an axial direction of the main valve 10.

The difference between Embodiment 1 and Embodiment 2 is that the plurality of supporting structures 30 are arranged between the second side wall 242 and the side wall of the main valve 10 and between the fourth side wall 244 and the side wall of the main valve.

Moreover, in Embodiment 2, an outer surface of the supporting member 31 is a convex curved surface, and transition of the supporting member 31 is smoother such that scratching may be avoided. The supporting member 31 extend in the axial direction of the main valve 10, and a length of the supporting member 31 is greater than or equal to a size of the connecting plate 24 in the axial direction of the main valve 10. In other embodiments, the outer surface of the supporting member 31 may be set as a concave curved surface.

According to the reversing valve provided in Embodiment 2, connection strength and connection stability of the main valve 10 and the supporting frame 20 may be also enhanced by the supporting structure 30, so as to satisfy use requirements.

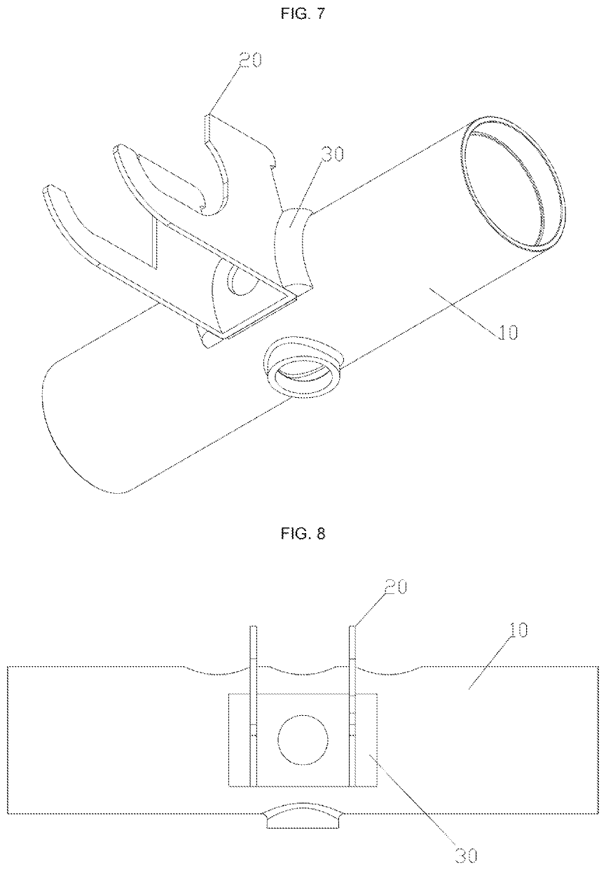

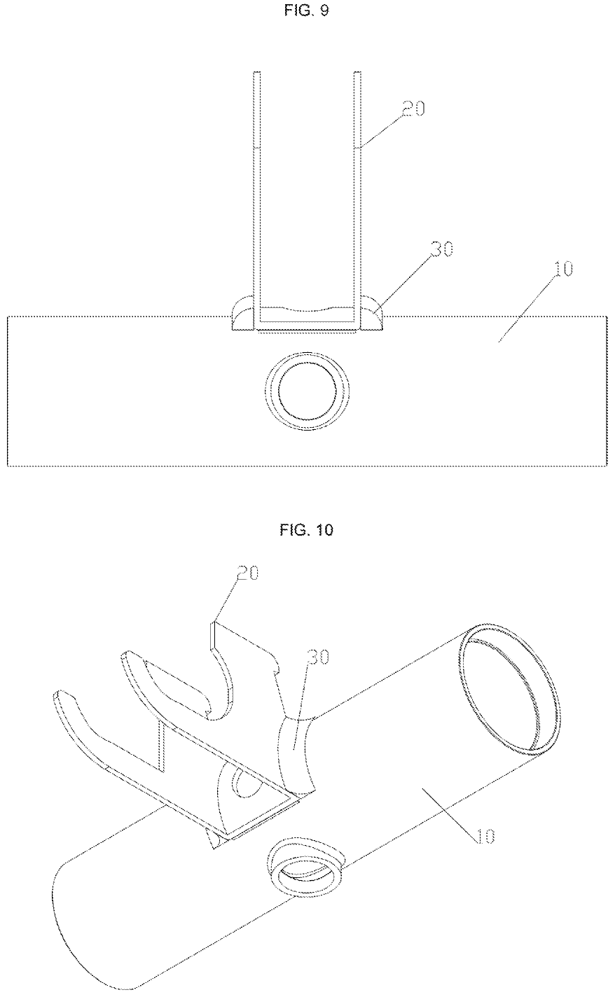

As shown in FIGS. 7-9, Embodiment 3 of the disclosure provides a reversing valve. The difference between Embodiment 3 and Embodiment 1 is that the outer surface of the supporting member 31 is the convex curved surface in Embodiment 3.

The supporting member 31 extends in the circumferential direction of the main valve 10, and a length of the supporting member 31 is greater than or equal to a size of the connecting plate 24 in the circumferential direction of the main valve 10.

In the embodiment, the section shape of the supporting member 31 is a sector.

According to the reversing valve provided in Embodiment 3, connection strength and connection stability of the main valve 10 and the supporting frame 20 may be also enhanced by the supporting structure 30, so as to satisfy use requirements.

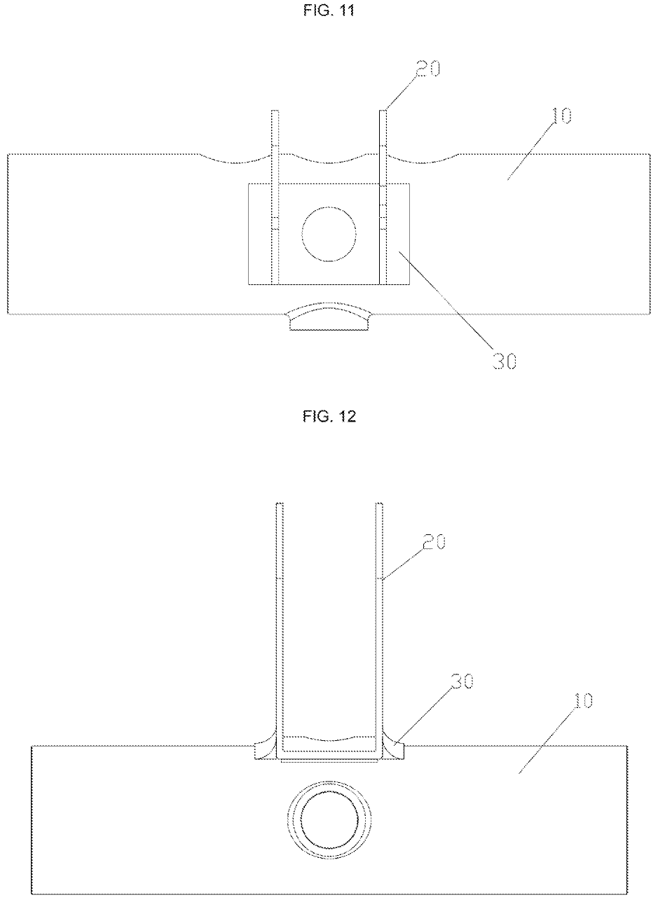

As shown in FIGS. 10-12, Embodiment 4 of the disclosure provides a reversing valve. The difference between Embodiment 4 and Embodiment 3 is that the outer surface of the supporting member 31 is the concave curved surface in Embodiment 4.

According to the reversing valve provided in Embodiment 4, connection strength and connection stability of the main valve 10 and the supporting frame 20 may be also enhanced by the supporting structure 30, so as to satisfy use requirements.

The above embodiments are merely preferred embodiments of the disclosure, and are not intended to limit the disclosure, and various modifications and changes can be made on the disclosure by those skilled in the art. Any modifications, equivalent substitutions, improvements, and the like within the spirit and principles of the disclosure are intended to be included within the scope of protection of the disclosure.

1. A reversing valve, comprising:
a main valve;
a supporting frame having a first connecting end and a second connecting end, wherein the first connecting end is connected with the main valve, and an end wall of the first connecting end is attached to a side wall of the main valve; and
a supporting structure located between a side wall of the first connecting end and the side wall of the main valve.

2. The reversing valve according to claim 1, wherein the supporting frame comprises a frame body and a connecting plate that are connected to each other, a surface of the connecting plate is attached to the side wall of the main valve, and
the supporting structure is located between a side wall of the frame body and the side wall of the main valve; and/or
the supporting structure is located between a side wall of the connecting plate and the side wall of the main valve.

3. The reversing valve according to claim 2, wherein the frame body comprises a first supporting plate and a second supporting plate, the first supporting plate and the second supporting plate are arranged at an interval in an axial direction of the main valve, two ends of the connecting plate are connected with the first supporting plate and the second supporting plate respectively, there are a plurality of supporting structures, and the plurality of supporting structures are arranged between an outer side wall of the first supporting plate and the side wall of the main valve and between an outer side wall of the second supporting plate and the side wall of the main valve.

4. The reversing valve according to claim 2, wherein the connecting plate comprises a first side wall, a second side wall, a third side wall and a fourth side wall, the first side wall and the third side wall both extend in a circumferential direction of the main valve, the second side wall and the fourth side wall both extend in an axial direction of the main valve, there are a plurality of supporting structures, and the plurality of supporting structures are arranged between the second side wall and the side wall of the main valve and between the fourth side wall and the side wall of the main valve.

5. The reversing valve according to claim 1, wherein the supporting structure comprises a supporting member, and the side wall of the first connecting end and the side wall of the main valve are connected with the supporting member respectively.

6. The reversing valve according to claim 5, wherein a section shape of the supporting member comprises a triangle, a rectangle, a sector or a circle.

7. The reversing valve according to claim 5, wherein an outer surface of the supporting member is a concave curved surface or a convex curved surface.

8. The reversing valve according to claim 1, wherein the first connecting end is connected with the main valve through argon arc welding, and the supporting structure is a stacked material formed by welding.

9. The reversing valve according to claim 5, wherein the supporting member is welded between the side wall of the first connecting end and the side wall of the main valve.

10. The reversing valve according to claim 1, further comprising a pilot valve, wherein the pilot valve is connected with the second connecting end.

11. The reversing valve according to claim 8, wherein the supporting frame comprises a frame body and a connecting plate that are connected to each other, a surface of the connecting plate is attached to the side wall of the main valve, and
the supporting structure is located between a side wall of the frame body and the side wall of the main valve; and/or
the supporting structure is located between a side wall of the connecting plate and the side wall of the main valve.

12. The reversing valve according to claim 11, wherein the frame body comprises a first supporting plate and a second supporting plate, the first supporting plate and the second supporting plate are arranged at an interval in an axial direction of the main valve, two ends of the connecting plate are connected with the first supporting plate and the second supporting plate respectively, there are a plurality of supporting structures, and the plurality of supporting structures are arranged between an outer side wall of the first supporting plate and the side wall of the main valve and between an outer side wall of the second supporting plate and the side wall of the main valve.

13. The reversing valve according to claim 11, wherein the connecting plate comprises a first side wall, a second side wall, a third side wall and a fourth side wall, the first side wall and the third side wall both extend in a circumferential direction of the main valve, the second side wall and the fourth side wall both extend in an axial direction of the main valve, there are a plurality of supporting structures, and the plurality of supporting structures are arranged between the second side wall and the side wall of the main valve and between the fourth side wall and the side wall of the main valve.

14. The reversing valve according to claim 8 wherein the supporting structure comprises a supporting member, and the side wall of the first connecting end and the side wall of the main valve are connected with the supporting member respectively.

15. The reversing valve according to claim 14, wherein a section shape of the supporting member comprises a triangle, a rectangle, a sector or a circle.

16. The reversing valve according to claim 14, wherein an outer surface of the supporting member is a concave curved surface or a convex curved surface.

17. The reversing valve according to claim 9, wherein a section shape of the supporting member comprises a triangle, a rectangle, a sector or a circle.

18. The reversing valve according to claim 9, wherein an outer surface of the supporting member is a concave curved surface or a convex curved surface.

19. The reversing valve according to claim 10, wherein the supporting frame comprises a frame body and a connecting plate that are connected to each other, a surface of the connecting plate is attached to the side wall of the main valve, and
the supporting structure is located between a side wall of the frame body and the side wall of the main valve; and/or
the supporting structure is located between a side wall of the connecting plate and the side wall of the main valve.

20. The reversing valve according to claim 19, wherein the frame body comprises a first supporting plate and a second supporting plate, the first supporting plate and the second supporting plate are arranged at an interval in an axial direction of the main valve, two ends of the connecting plate are connected with the first supporting plate and the second supporting plate respectively, there are a plurality of supporting structures, and the plurality of supporting structures are arranged between an outer side wall of the first supporting plate and the side wall of the main valve and between an outer side wall of the second supporting plate and the side wall of the main valve.
